(19) United States
(12) Patent Application Publication
(10) Pub. No.: US 2012/0074120 A1
(43) Pub. Date: Mar. 29, 2012

(54) Electrically Heated Plastic Part for a Vehicle

(76) Inventors: Andreas Massold, Balingen (DE); Frank Sommer, Balingen (DE)

(21) Appl. No.: 13/231,520

(22) Filed: Sep. 13, 2011

(30) Foreign Application Priority Data
Sep. 23, 2010 (EP) 10 010 284.7

(51) Int. Cl. H05B 3/06

(52) U.S. Cl. 219/385; 219/520

(57) ABSTRACT

The invention relates to an electrically heated plastic part, for example a fuel hose, windshield wiper fluid hose or some other type of hose for a vehicle. Two electrically connected wires are embedded in one wall of the hose as electrical resistance heating conductors that, for example, extend helically and are twisted together, the wires requiring electrical insulation if they are twisted. The invention proposes using wires composed of different metals and connecting them with one another at a connection point. In this manner, a thermocouple is formed that makes it possible to measure the temperature at the connection point.

### FIELD OF THE INVENTION

The invention relates to an electrically heated plastic part for a vehicle and particularly to a plastic part of a vehicle including different types of land vehicles, watercrafts, and aircrafts. The plastic part can be, for example, a housing or a holder of an exterior rear view mirror, a fuel line, a housing or other part of a fuel filter, a spray nozzle, or a hose of a windshield washer system. Other possible applications of the invention are as a fresh-water or waste-water tank or as a toilet of a recreational vehicle or trailer. The listing of possible applications is not exhaustive.

### BACKGROUND OF THE INVENTION

The utility model DE 299 23 550 U1 discloses an electrically heated hose for a windshield washer system of a vehicle. The hose has two electrical resistance heating wires that extend parallel to one another in the longitudinal direction of the hose and are furthermore embedded in a hose wall. At one end of the hose, both heating wires are connected to a heat loop that is located in a spray nozzle housing. At the other end of said hose, both of the heating wires are electrically contactable for heating purposes.

The object of the invention is to develop an electrically heated plastic part with which it is possible both to measure temperature and to provide a heating function.

### SUMMARY OF THE INVENTION

This object is solved according to the invention in that two electrical resistance heating wires of a plastic part form a thermocouple. That means that both heating conductors are electrically connected to one another at a connection point and that they moreover consist of different materials. The connection point forms a temperature measurement location that, for example, need not be arranged on the end of a hose. A temperature difference between the connection point and electrical terminals of the heating conductors brings about an electric potential between the electrical terminals, which electric potential can be used to measure the temperature at the connection point of both of the heating conductors. The heating conductors can consist of metals, semiconductor materials that, for example, are differently doped, electrically-conductive plastics or a combination of such materials. The listing of materials is not exhaustive. It is essential that a difference in temperature between the connection point of the heating conductor and its electrical terminals generates an electric potential between the electrical terminals that can be measured to determine the temperature of the connection point. The heating current is switched off, and the heating element allowed sufficient time to come to thermal equilibrium with the surrounding material, to effect temperature measurement. To simplify temperature readings, the electrical terminals are kept at a single, known, temperature (for example by means of an electrically insulating, isothermal connector block).

The invention has the advantage that the heating conductors necessary for heating can also be used for temperature measurements. The heating elements can be powered in a targeted manner if there is the risk of, for example, an exterior rear view mirror, a hose or a spray nozzle for windshield washer fluid fogging up or icing over or a so-called gelling (formation of paraffin crystals) of diesel fuel. Obviating icing over is, for example, also an application of the invention for aircraft, for example. Fuel, regardless whether gasoline, diesel or kerosene, can also be pre-heated to a pre-determined temperature in order to save fuel. That is quite different from the “gelling” of diesel fuel and always takes place at a higher temperature.

A configuration of the invention provides that the heating conductors are embedded within the plastic, for example are insert molded with the plastic. The heating conductors are thereby both protected from contact with liquids, should the plastic part conduct fluids, as well as from an external electrical contact that could lead to a short circuit, for example.

A further configuration of the invention provides that the plastic part is a container. The meaning of container is to be understood as, for example, a hose or tube for fuel or water, for example, or further as a housing or as a part of a housing such as a fuel filter or a windshield washing nozzle. In this configuration of the invention, it is possible to prevent, for example, windshield washer fluid from freezing and diesel fuel from gelling; said configuration of the invention furthermore makes it possible for fuel in general to reach an internal combustion engine at a pre-determined minimum temperature. Since the temperature of the fluid can be measured, unnecessarily heating fuel to a temperature above the required temperature can be prevented.

Yet another configuration provides that at least one heating conductor is arranged helically, enclosing an interior space of the container in a wall of the container. The configuration of one or more helically-positioned heating conductor(s), each electrically isolated from any of the one or more helically-positioned heating conductor(s), enclosing an interior space creates a relatively large contact surface for heat transfer. The helical shape of the heating conductor is possible in both a hose or cylindrical housing or housing part as well as in a housing or housing part that is conical, for example.

An even further configuration of the invention provides one or more pairs of electrical resistance heating wires from which two, as a pair, are connected to one another at a connection point in an electrically conducting manner. At their other ends, either one heating conductor of a heating conductor pair be connected with another heating conductor of a different heating conductor pair, the heating conductor pairs thereby being electrically connected in series, or the heating conductor pairs can be electrically connected in parallel or electrically isolated from one another. This configuration of the invention provides, liner cilia, an alternative to a helical arrangement, the heating conductors being able to be arranged parallel to one another in the longitudinal direction of a hose or cylindrical housing or housing part. The hose or housing is nevertheless heated across its entire breadth. An additional advantage of this configuration of the invention is that it is possible to measure temperature at various locations such as in the longitudinal and/or circumferential direction.

A further configuration of the invention provides for a twisting of the heating conductors that makes possible a space-saving arrangement. In this instance, the heating conductors are most preferably electrically insulated.

The heating conductors can be configured of wire, for example, or be configured as conductor paths. The conductor paths can be films or they can be vapor-or chemically-deposited, for example, as is customary with semiconductors. Conductor paths made out of stamped sheet metal, for example, are a further possibility. This configuration of the invention makes it possible for the heating conductors to be arranged in variously shaped spatial arrangements.

### BRIEF DESCRIPTION OF THE DRAWINGS

The invention is explained in greater detail in the description that follows by way of embodiments illustrated in the drawing wherein:

FIGS. 1 and 2 show two electrically heated hoses according to the invention;

FIG. 3 shows an electrically heated filter housing part according to the invention; and

FIG. 4 shows in an exploded view an exterior rear view mirror for a vehicle having an electrically heated holder according to the invention.

### DETAILED DESCRIPTION OF PREFERRED EMBODIMENTS

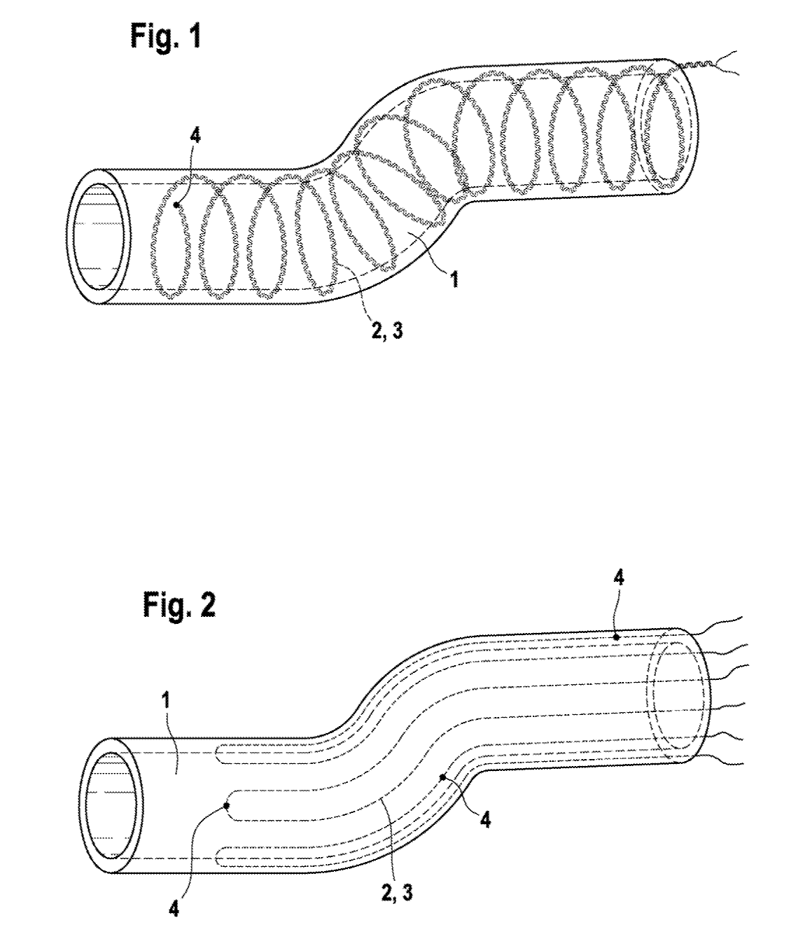

The hose 1 according to the invention shown in FIG. 1 consists of plastic or rubber and is provided as a fuel or windshield washer fluid hose; other uses are not excluded. Two metal wires 2 forming the electrical resistance heating conductors 3 are embedded in one wall of the hose 1. Both of said wires 2 are entirely surrounded by the plastic or rubber of the wall of the hose 1 and they reach neither an exterior side nor an interior side of a surface of the hose 1. Both of the wires 2 have an electrically insulating jacket so that they do not come into electrically conductive contact with one another and they are furthermore twisted. Both of the wires 2 extend helically in the wall of the hose 1. Near one end of the hose 1, both of the wires 2 are connected to one another at a connection point 4 in an electrically-conductive manner through laser beam welding or a different method. At a different location or at a different end, both of the wires 2 emerge from the hose 1 to electrically contact with a power source that is not shown. By supplying with current both of the wires 2 that form the heating conductor 3, the hose 1 can also be heated.

Each of the two wires 2,3 consists of different metals and they accordingly form a thermocouple with which the temperature at the connection point 4 can be measured, the current supply being cut off for temperature measurement and thermoelectric voltage being measured on the ends of the wires 2,3 that emerge from the hose 1. Differently from shown, the connection point 4 can also be situated at a different location aside from one end of the hose 1. Because of the possibility of measuring temperatures, a fluid in the hose 1 can be intentionally held at a pre-determined temperature without requiring heating to an unnecessarily high temperature. For example, fuel can be pre-heated to a pre-determined temperature which saves fuel and furthermore prevents both “gelling” (formation of paraffin crystals) or diesel fuel as well as freezing of water or fluid.

FIG. 2 shows wires 2,3, which are each composed of different metals, connected to one another in an electrically conductive manner as a pair at connection point 4. As shown in FIG. 1, the wires 2,3 are embedded in a wall of a hose 1; however, the wires 2,3, which also form the electrical resistance heating conductors in FIG. 2, are not helical but rather are arranged parallel to one another extending in the longitudinal direction of the hose 1. The wires 2,3, then, are arranged to be distributed throughout a circumference of the hose 1, resulting in a hose wall being heatable over its entire circumference. The connection point 4 and two different metals for each of the wires 2,3 that create a pair form together these thermocouples with which a temperature at the connection points 4 can be measured. The connection points 4 can be arranged in the longitudinal direction at different points on the hose 1, thereby making it possible for temperature measurements at different locations on the hose 1 in the longitudinal direction. The wires 2,3 of the hose 1 shown in FIG. 2 do not require any electrical insulation because they are distanced from one another with the exception of the connection points 4 and, owing to the plastic or rubber of the wall of the hose 1, are furthermore electrically insulated from one another as well as from exterior and interior sides of the hose.

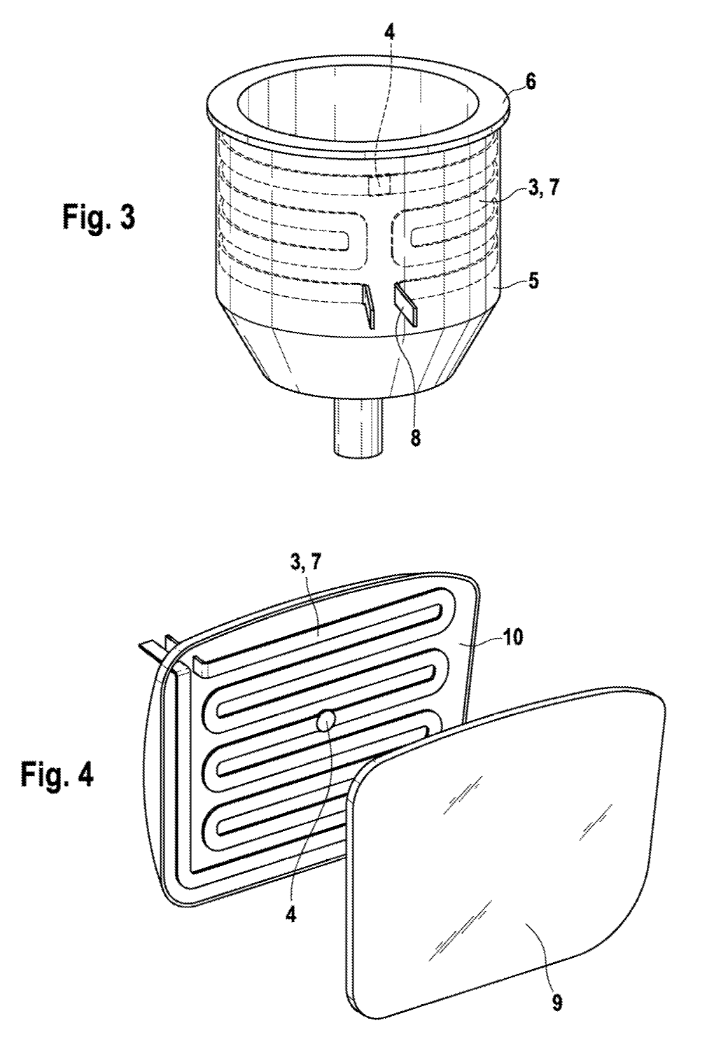

FIG. 3 shows a filter housing part of fuel filter or other type of filter. The housing part 5 is cup-shaped and has a flange 6 composed of plastic for welding to or adhering with a housing lid that is not shown. Prior to the sealing of the housing part 5 with the lid that is not shown, a filter, which is likewise not shown, is arranged either in the lid or in the housing part 5. Two conductor paths 3,7 that are punched from sheet metal, are curved in a semi-cylindrical shape, and extend in a serpentine manner are embedded in one wall of the housing part 5. Each of the two conductor paths 3,7 are composed of different metals and are directly connected to one another, for example by any of the various autogenous welding techniques such as electron beam welding, laser welding, GTAW, PAW, in an electrically conductive manner at a connection point 4 in such a manner that they form a thermocouple with which temperature at the connection point 4 can be measured. The far end of the conductor paths 3,7 farthest from the connection point 4 are curved outward and protrude from the filter housing part 5 in such a manner that they can be electrically contacted. The conductor paths 3,7, as previously mentioned, form both a thermocouple and electrical resistance heating conductors 3,7 with which the filter housing part 5 can be heated.

FIG. 4 shows an exterior rear view mirror 9 with a plate-shaped holder 10 to which the back side of the rear view mirror 9 is adhered. A housing of the exterior rear view mirror is not shown. The plate-shaped holder 10 consists of plastic and can furthermore have ribs on its rear side, which is not visible in the drawing, for reinforcement. On a front side of the holder that is opposite the rear view mirror 9, the holder 10 has two serpentine-shaped conductor paths 3,7 that can be, for example, adhered to the holder 10 as film strips or can be deposited thereon, as conductor paths are on a printed circuit board. Both of the conductor paths 3,7 form the electrical resistance heating conductors. Both of the conductor paths 3,7 overlap at one connection point 4 and are directly connected to one another in an electrically conductive manner. Both of the conductor paths 3,7 consist of different metals in such a manner that they form a thermocouple with which the temperature at the connection point 4 can be measured. The respective other ends of the conductor paths 3,7 are conducted through the plate-shaped holder 10 in order to be able to electrically contact the conductor paths 3,7. The holder 10 forms an electrically heated plastic part within the meaning of the invention.

The configuration of both of the conductor paths 3,7 as thermocouple makes it possible, as previously stated, to measure the temperature at the connection point 4 in order to heat the rear view mirror 9 if there is the likelihood of freezing so as to be able to prevent a fogging up from occurring and the subsequent formation of frost or, alternatively, to thaw frost. A heating current that flows through the conductor paths 3,7, which form the electrical resistance heating conductors, is switched off, and the conductors 3,7 allow to come to thermal equilibrium with its surrounding material, to effect temperature measurement. It is possible to embed the conductor paths 3,7 in the plastic of the holder 10 instead of arranging them on a surface of the holder, as shown. The invention is not limited to planar parts such as the plate-shaped holder 10 of the exterior rear view mirror 9; the conductor paths 3,7 that form both the electrical resistance heating conductors and a thermocouple, can also be arranged in plastic parts that are neither flat nor planar but that, for example, are bent or have edges (not shown).

1. An electrically heated plastic part that comprises:
two electrical resistance heating conductors that are electrically connected at a connection point wherein the heating conductors are made of different materials such that the heating conductors form a thermocouple that can be used to measure the temperature at the connection point.

2. The electrically heated plastic of claim 1 wherein the plastic part is a container.

3. The electrically heated plastic part of claim 1 wherein the heating conductors are embedded in the plastic.

4. The electrically heated plastic part of claim 2 wherein the plastic part is a container.

5. The electrically heated plastic part of claim 4 with at least one heating conductor is either configured in a helical or serpentine manner in an interior space of the container or arranged on or in a wall of the container.

6. The electrically heated plastic part of claim 1 wherein the plastic part has two or more pairs of electrical resistance heating conductors that are connected to one another in an electrically conductive manner at connection points and that are made of different materials such that they form a thermocouple that can be used to measure the temperature at the connection points.

7. The electrically heated plastic part of claim 1 wherein the electrically insulated heating conductors are twisted about each other.

8. The electrically heated plastic part of claim 1 wherein the heating conductors are not twisted about each other.

9. The electrically heated plastic part of claim 1 wherein the heating conductors comprise one electrical conduction path.

10. The electrically heated plastic part of claim 1 wherein the two electrical resistance heating conductors are directly connected in an electrically conductive manner at only a single connection point.

11. The electrically heated plastic part of claim 1 wherein the plastic part is a vehicle part.

12. A method of heating a plastic part which comprises the steps of:
(a) embedding two electrical resistance heating conductors in the plastic part, wherein the conductors are formed of different materials and are electrically connected at a connection point such that the heating conductors form a thermocouple; and
(b) applying current to at least one of the heating conductors.

13. The method of claim 12 further comprising the steps of stopping the application of the current for a sufficient length of time to allow the temperature of the plastic part and the heating conductors to equilibrate and then measuring the temperature of the plastic part by measuring temperature by measuring the voltage between ends of the two heating conductors.

14. The method of claim 12 wherein the plastic part is a container.

15. The method of claim 14 with at least one heating conductor is either configured in a helical or serpentine manner in an interior space of the container or arranged on or in a wall of the container.

16. The method of claim 12 wherein the plastic part has two or more pairs of electrical resistance heating conductors that are connected to one another in an electrically conductive manner at connection points and that are made of different materials such that they form a thermocouple that can be used to measure the temperature at the connection points

17. The method of claim 12 wherein the electrically insulated heating conductors are twisted about each other.

18. The method of claim 12 wherein the heating conductors are not twisted about each other.

19. The method of claim 12 wherein the heating conductors comprise one conduction path.

20. The method of claim 12 wherein the two electrically resistance heating conductors are directly connected in an electrically conductive manner at only a single connection point.
